(19) United States
(12) Patent Application Publication
(10) Pub. No.: US 2014/0331621 A1
(43) Pub. Date: Nov. 13, 2014

(54) SADDLE PAD, IN PARTICULAR FOR USE AS A PAD FOR A WESTERN SADDLE

(71) Applicant: Brian Kronborg JESPERSEN, Hjallerup (DK)

(72) Inventor: Brian Kronborg JESPERSEN, Hjallerup (DK)

(21) Appl. No.: 13/892,943

(22) Filed: May 13, 2013

(51) Int. Cl. B68C 1/12

(52) U.S. Cl. CPC B68C 1/12
USPC 54/66

(57) ABSTRACT

By configuring a saddle pad, in particular as a pad for a western saddle, comprising a felt cover (2), in which two air cushion (8, 8′) is inserted into pockets (7, 7′) on each side of the central line of the pad, and such that each cushion partly fills at least the front half of the cavity and partly is provided with barrier walls (13, 14, 15 and 13′, 14′, 15′) extending from the rear wall of the cushion and a distance forwardly, the engagement pressure from the saddle on the horse will be reduced, and at the same time the rider will remain in good contact with the horse.

The two cushions are connected to a single pump (21) adapted to supply the same pressure in the two cushions thereby leading to a better comfort for the rider and the horse during riding.

### THE PRIOR ART

The invention relates to a western saddle, comprising a pad having an upper layer, preferably made of felt and an associated lower layer, said lower layer consisting of two layers that are stitch together thereby forming two cavities in which a flexible air-tight cushion is accommodated in a cavity, said cushion being provided with an air valve for inflating the air cushion, said air cushion is attached to a flexible carrier member.

A saddle pad of this type serves to keep the saddle clean and to absorb the sweat, which would otherwise make the saddle slippery, involving the danger that it will slide on the horse.

There is a special need for a pad when riding in a so-called western saddle, as the special configuration of this makes it heavy and moreover stiff to enable it to withstand the pull from a lasso, when this is secured to the saddle knob, the horn.

The weight and the stiffness often result in pressure injuries on the horse, and since the stiff configuration has a limited contact face with the back of the horse, there will a great risk of so-called pressure injuries on the horse.

It is known to provide saddle pads with pressure absorbing and pressure-distributing pads inserted into a saddle pad. Thus, it is known from U.S. Pat. No. 7,137,236 B2 to insert a foam cushion (20) in the pad, said cushion absorbing and distributing the weight.

This solution, however, is not suitable for riding in a western saddle, since the contact with the horse is transferred as a resilient and thereby “soft” contact, which is inexpedient. To this should be added that the pressure absorbing capacity of the cushions will be impaired after a short period of use, because the foam will be compressed to the detriment of the pressure distribution, which will be reduced correspondingly.

To remedy this defect, it is known from EP 1 837 302 A1 to insert an air-filled cushion into the pad on each side of the central line.

These two cushions will be able to distribute the weight, but this solution, too, is not suitable for use when riding in a western saddle. The air in the cushion will be distributed such that there will be least air where the pressure is greatest such that the saddle and thereby the rider will feel as if he was sitting on an air cushion. This feeling of a swimming or rocking riding makes the pad unsuitable for use below a western saddle.

U.S. Pat. No. 5,555,710 disclose a western saddle of the type defined in the introductory part of claim 1.

According to this document two inflatable cushions are formed as one cushion being form as two cushions that are connected by communicating channels, where the channels is provided with one valve.

By having two cushions that are connected this will result in that air from one cushion will move to the other cushion due to the movements of the horse during ridding. This means that the ridder will feel a rocking movement of the saddle to the discomfort for the ridder and the horse as well.

### THE OBJECT OF THE INVENTION

It is the object of the invention to increase the flexibility and improve the comfort for a rider and his horse under ridding, and this is achieved according to the invention by a pad, wherein the cushion is formed as two separate cushions, each of which has an air valve and in that a pump unit is connected to the valves.

It is an advantage if, as stated in claim 2 the pump unit is fixed to a male connection part having two male outlets, said outlets being connectible to a female connection part having two female inlets, said female connection part is fixed to the two valves. In this way the same pressure in the two cushions are achieved.

As stated in claim 3, that the male connection part has two tongues adapted to grip the female connection part, a useful quick releasable connection is achieved.

When, as stated in claim 4, the one or more barrier walls are arranged at the rear in each cushion, said barrier walls extending from the rear wall of the cushion and a distance forwardly, the tendency of the air to move in the cushion, viz. away from the pressure area, will be limited additionally, as the walls will serve as boundaries for the movement of the air in the cushion.

When, as stated in claim 5, the at least one of the barrier walls extends essentially in parallel with the central line of the pad, and that at least one barrier wall extends between the rear wall of the cushion and the outermost lateral wall, the air cushions will be disposed at the most effective locations, viz. where the saddle rests and presses against the back of the horse.

When, as stated in claim 6, the barrier walls have a length, which essentially corresponds to half the length of the cushion, wave motions of the air will be limited as much as possible.

When, as stated in claim 7, the barrier walls are formed by stitching the opposed cushion layers together, it will be ensured that the cushions do not get too bulky, that is thick, and also that they remain relatively flat.

When, as stated in claim 8, the cushions (8, 8′) are made of airtight sheet, the assembly to form the walls may take place by hot melting or vulcanization.

### THE DRAWING

An example of an embodiment of a saddle pad according to the invention will be described more fully below with reference to the drawing, in which

FIG. 1 shows a saddled horse with a western saddle and a pad according to the invention,

FIG. 2 shows the pad on FIG. 1, seen with its upside turned down,

FIG. 3 shows the pad on FIG. 2 with open cavities,

FIGS. 4 and 6 show left and right cushions, respectively,

FIGS. 5 and 7 show a sectional view of left and right cushions, respectively, seen in the direction V-V in FIG. 4 and VII-VII in FIG. 6,

FIG. 8 shows in a preferred embodiment of the invention a connection part to the valves on FIG. 3,

FIG. 9 shows a pump unit connectible to the connection part on FIG. 8, and

FIG. 10 shows the pump unit connected to the connection part on FIG. 8, and

FIG. 11 shows from above the pad on a horse without saddle.

### DESCRIPTION OF THE EXEMPLARY EMBODIMENTS

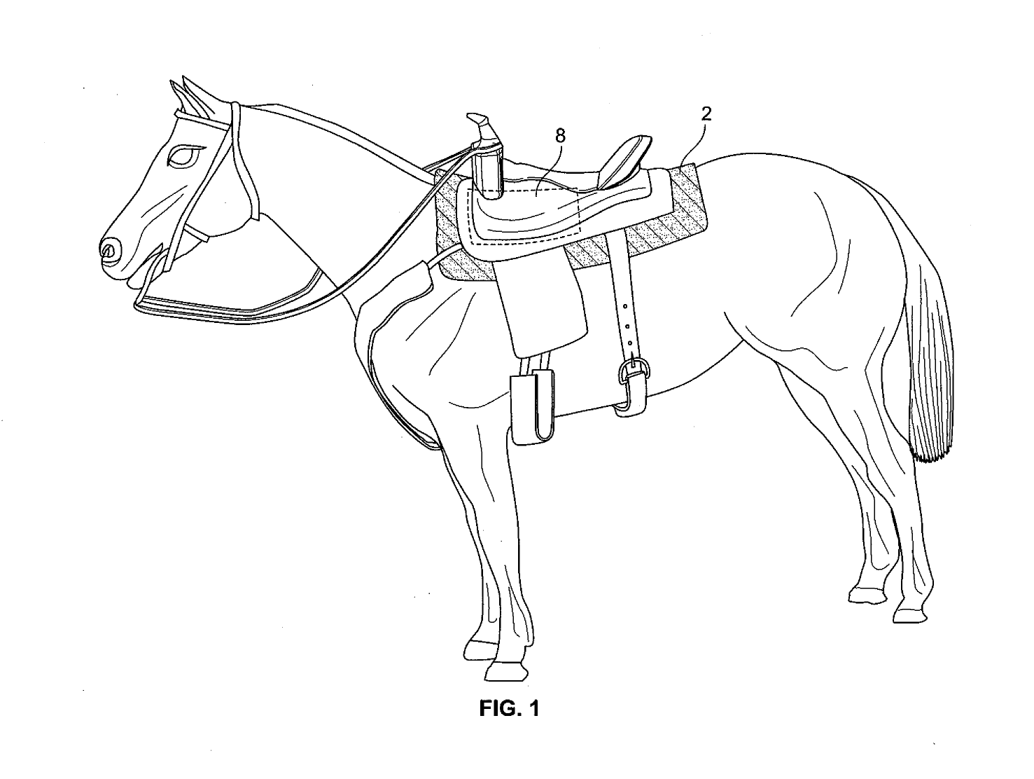

The invention will be described below based on an example of a saddle pad 2, which, as shown in FIG. 1, is used in connection with a western saddle.

Such a saddle is characterized in that it is a stiff saddle in contrast to a leather saddle, and provided at the front with a horn at the centre at the seat and a cantle.

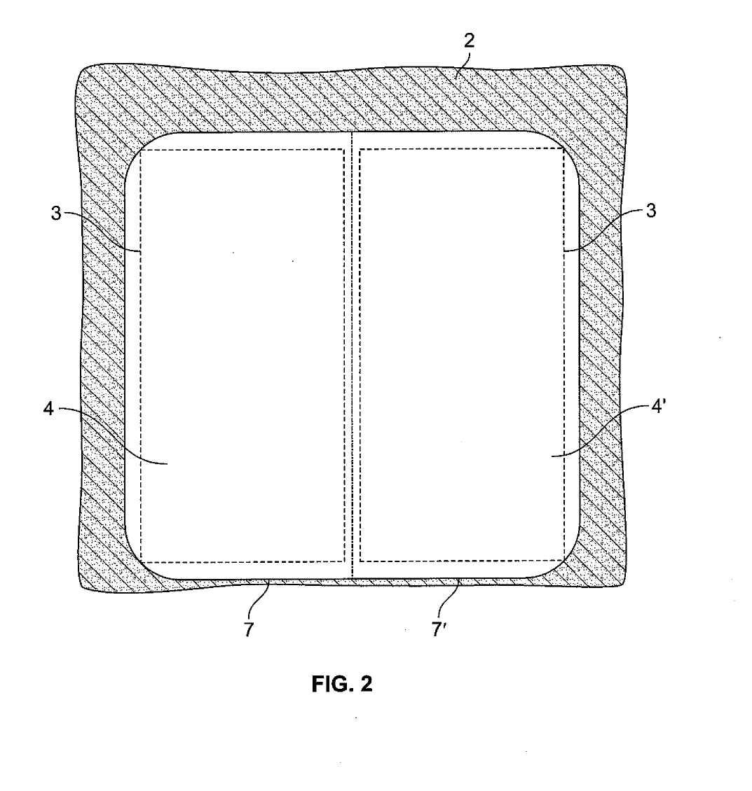

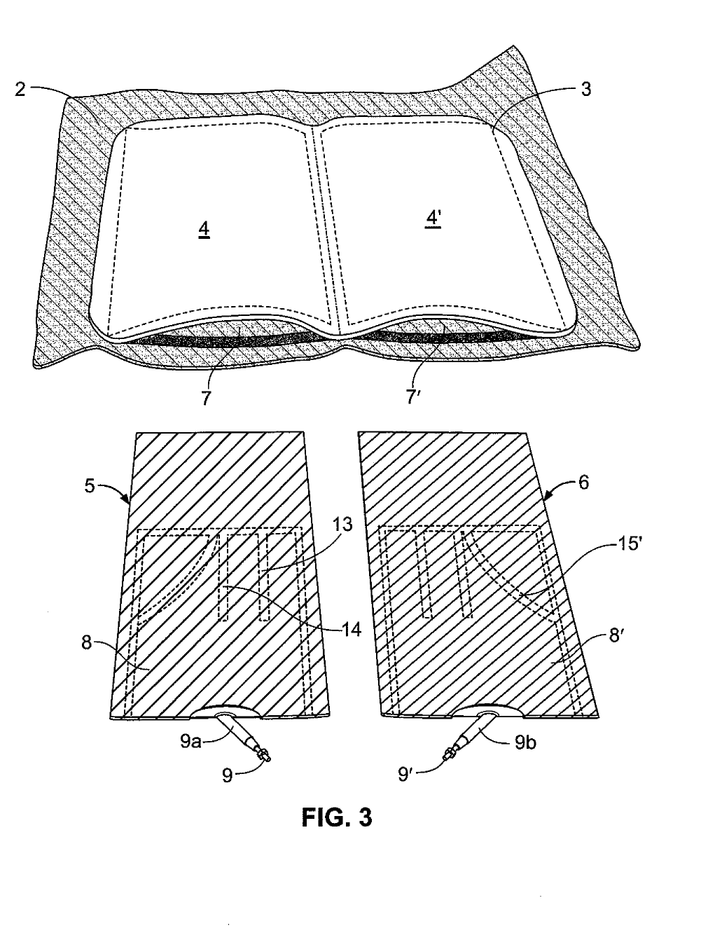

The pad 2 is shaped with a so-called schabrack shape, which is a four-sided shape, as shown in FIG. 2 and FIG. 3.

The pad comprises an upper layer made of strong felt 2 and of two double layers 4, 4′ that are stitch together, and stitch to the felt 2, as indicated by the dashed line 3. These double layers defines two cavities or pockets 7, 7′ adapted to receive flexible carrier members 5,6′ on which upper surfaces two air cushings 8.8 cf. below are arranged. Where it is desired to have the option of exchanging the carrier members 5 6′, the front edges of the double layers are not stitched together, but may be provided with some form of closure, such as a Velcro closure, as indicated by 34 in FIG. 3.

Each cushion 8 and 8′ is made of an airtight material, so that they may be inflated via a valve 9, 9a and 9′, 9b. The purpose of these cushions is to absorb and distribute the pressure, which is exerted by the saddle on the back of the horse. This provides protection against pressure injuries, just as the engagement of the saddle with the horse may be adapted by a suitable selection of the air pressure.

To ensure the desired contact between rider and horse, however, the saddle must be secured to the horse more or less immovably.

This is a requirement for the pad to operate in connection with a western saddle.

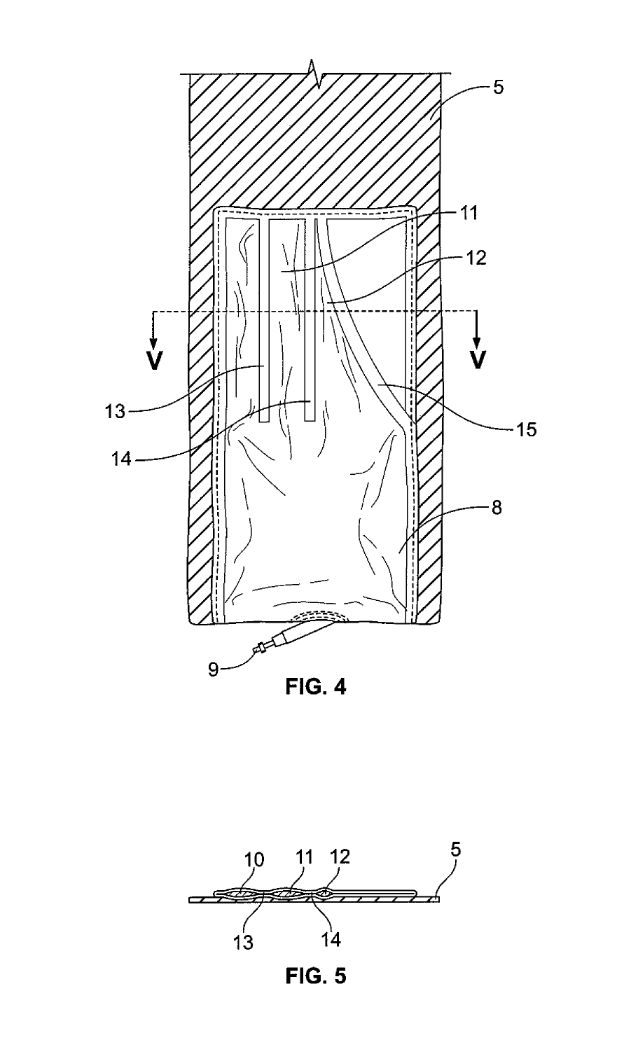

Therefore, as shown in FIGS. 4-7, the air cushions are provided with a cavity disposed at the front, said cavity being positioned at the contact area between the saddle and the horse, and with two partition walls 13, 14 and 13′, 14′ at the rear extending in parallel in the example shown.

These walls serve to limit the moment of the air during riding, as they partly reduce the volume in which the air is present and partly limit the flow between the various areas 11, 12 and 11′, 12′ in the cushion. Hereby, the air movements and the airflows are dampened, and the rider feels that there is a firm contact with the horse.

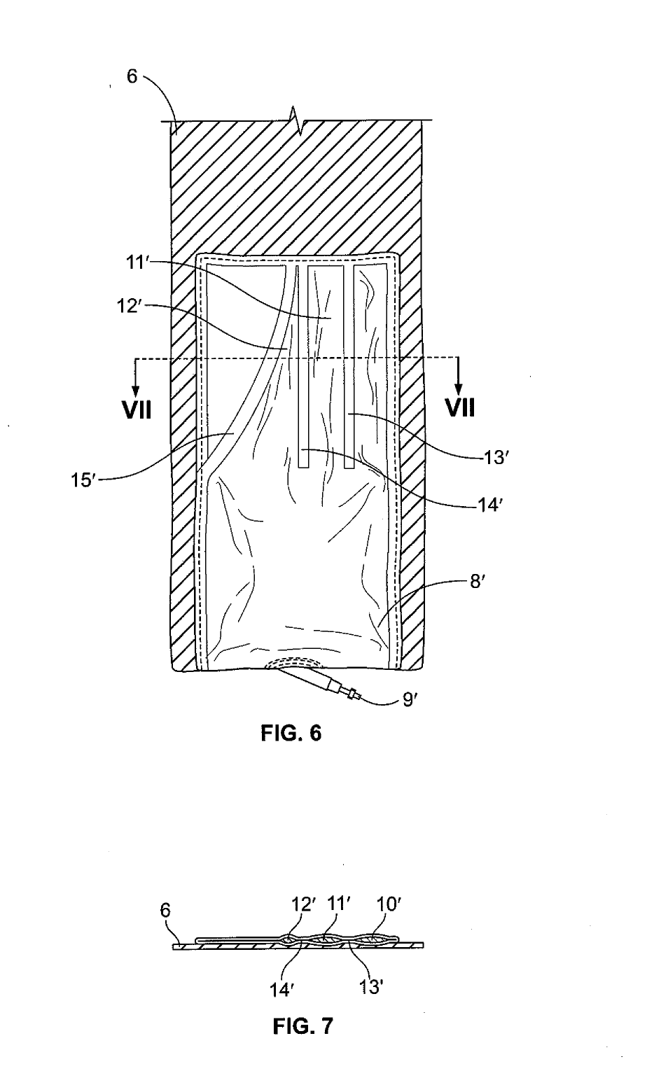

FIGS. 4 and 6 moreover show a barrier wall 15 and 15′, which extend between the rear side and the lowermost lateral edge. These walls serve to reduce the volume of air so that air will primarily be present where the engagement pressure is.

Valves 9, 9a and 9′, 9b are mounted for the regulation of the air pressure and/or the air volume in the cushions, said valves serving to supply air to the cushions and to allow the air pressure/air amount to be adjusted, such that the pressure from the saddle is distributed as best as possible across the back of the horse. This protects the horse against pressure injuries, and it is moreover ensured that the blood flow of the horse in the skin remains intact, thereby completely avoiding pressure sores.

The example shown includes partition walls extending in parallel and a boundary wall extending obliquely, but, of course, there may be more or fewer depending on the need for regulation of the airflow and the configuration of the air compartments of the cushion. This makes it possible to adapt the pad to the horse and the shape and size of the saddle.

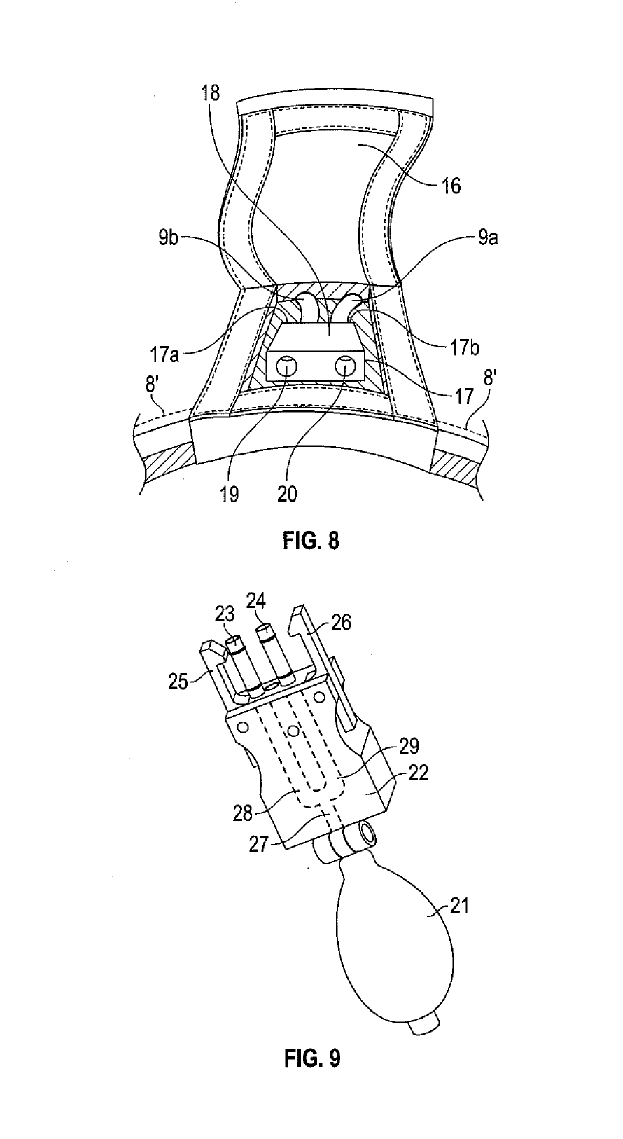

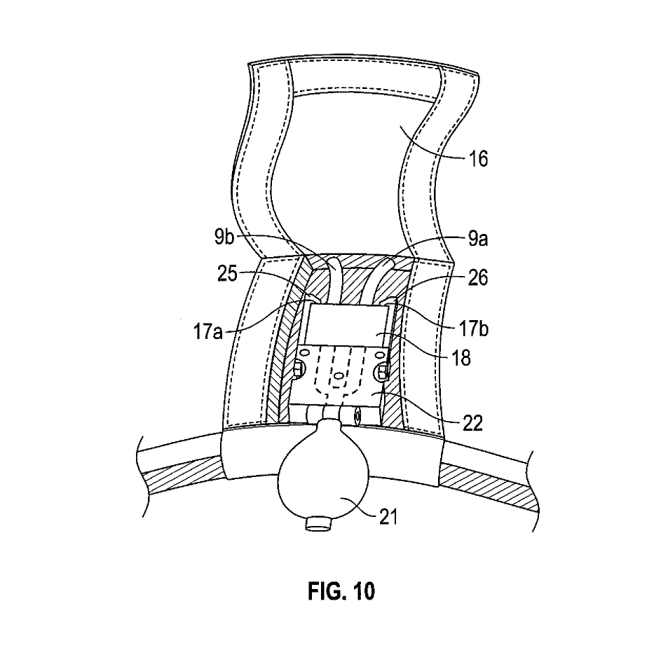

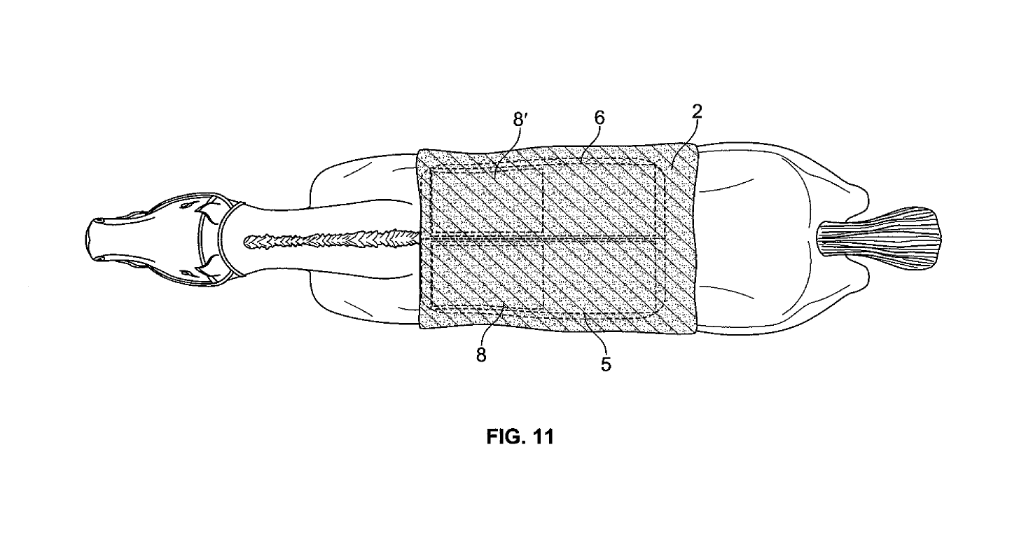

On FIG. 8, 18 denotes a female connection part that is fixed to the valves 9a, 9b.

16 denotes a closure the, here shown in open position, that is intended to cover the connection part 17.

The female connection part 17 has two female inlets 19, 20, adapted to receive male outlets 23, 24 arranged in a male connection part 22, cf. FIG. 9.

The male connection part 22 has two tongues 25, 26, that can be rotated around axis 30, 31. Two arcs in the male connection part 22 are denoted 32, 33.

A pump 21 is connected to the male connection part 22. As it can be seen, channels 27, 28, 29, shown with dashed lines are provided inside the male coupling part 22. When pump 21 is activated, then a flow in the channels will transmit flow to the male outputs 23,24 and further to the female inlets 19,29 than transmit air to the valves 9a, 9b and then into the cushions 8, 8′.

The devices shown connection part explained above is operated as follows.

When the male outputs 23, 24 in the female inlets 19, 20, then the tongues 25, 26 will provide a snap coupling so that the tongues will grip on edges 17a, 17b and hold the connection part in a form position.

When it is desired to free the male connection part 22 from the female connection part 18, then a pressure on the tongues in the arcs 31, 32 will force the tongues to be rotated around axis 30, 31 and disconnect the male connection part from the female connection part with a pull motion.

In FIG. 11, the connection parts are shown coupled together.

So by activating the pump, a pressure in the two cushions will be the same and secure a uniform behaviour of the saddle.

In the claims:

1. A western saddle, comprising a pad having an upper layer, preferably made of felt (2) and an associated lower layer, said lower layer consisting of two layers (4,4′) that are stitch together thereby forming two cavities (7,7′) in which flexible air-tight cushion is accommodated in a cavity, said cushion being provided with an air valve (9,9′) for inflating the air cushion, said air cushion is attached to a flexible carrier member (5,6), wherein, that the cushion is formed as two separate cushions (8,8″), each of which has an air valve and in that a pump unit (21) is connected to the valves (9, 9″).

2. A saddle pad according to claim 1 wherein, that the pump unit (21) is fixed to a male connection part (22) having two male outlets (23,24), said outlets being connectible to a female connection part (17) having two female inlets, said female connection part is fixed to the two valves (9,9′).

3. A saddle pad according to claim 2, wherein, that the male connection part has two tongues (25, 26) adapted to grip the female connection part.

4. A saddle pad according to claim 1, wherein, that one or more barrier walls (13, 14, 15 and 13′, 14′, 15′) are arranged at the rear in each cushion (8, 8′), said barrier walls extending from the rear wall of the cushion and a distance forwardly.

5. A saddle pad according to claim 4, wherein, that at least one of the barrier walls (13, 14 and 13′, 14′) extends essentially in parallel with the central line of the pad, and that at least one barrier wall (15, 15′) extends between the rear wall of the cushion and the outermost lateral wall.

6. A saddle pad according to claim 4, wherein, that the barrier walls (13, 14 and 13′, 14′) have a length, which essentially corresponds to half the length of the cushion (8, 8′).

7. A saddle pad according to claim 4, wherein, that the barrier walls (13, 14, 15 and 13′, 14′, 15′) are formed by stitching the opposed cushion layers together.

8. A saddle pad according to claim 1, wherein that the cushions (8, 8′) are made of air-tight sheet.
